(19) United States
(12) Patent Application Publication
(10) Pub. No.: US 2025/0240452 A1
(43) Pub. Date: Jul. 24, 2025

(54) METHOD FOR ENCODING/DECODING MULTI-PLANE STRUCTURE IMAGES AND RECORDING MEDIUM STORING INSTRUCTIONS FOR EXECUTING THE ENCODING METHOD

(71) Applicant: Electronics and Telecommunications Research Institute, Daejeon (KR)

(72) Inventors: Hong Chang SHIN, Daejeon (KR); Gwangsoon LEE, Daejeon (KR)

(73) Assignee: Electronics and Telecommunications Research Institute, Daejeon (KR)

(21) Appl. No.: 19/024,484

(22) Filed: Jan. 16, 2025

(30) Foreign Application Priority Data
Jan. 16, 2024 (KR) 10-2024-0006938

(51) Int. Cl. H04N 19/597; H04N 19/30

(52) U.S. Cl. CPC H04N 19/597; H04N 19/30

(57) ABSTRACT

An image encoding method according to the present disclosure may include deriving coefficients of a spherical harmonic function for a plurality of vertices on a three-dimensional space; generating a plurality of layer images based on the coefficients; and encoding the plurality of layer images. In this case, each of the plurality of layer images may include a coefficient value in order corresponding to the spherical harmonic function.

### TECHNICAL FIELD

The present disclosure relates to a method for encoding/decoding an immersive image which supports motion parallax for rotation and translation motions.

### BACKGROUND ART

A virtual reality service is evolving in a direction of providing a service in which a sense of immersion and realism are maximized by generating an omnidirectional image in a form of an actual image or CG (Computer Graphics) and playing it on HMD, a smartphone, etc. Currently, it is known that 6 Degrees of Freedom (DoF) should be supported to play a natural and immersive omnidirectional image through HMD. For a 6DoF image, an image which is free in six directions including (1) left and right rotation, (2) top and bottom rotation, (3) left and right movement, (4) top and bottom movement, etc. should be provided through a HMD screen. But, most of the omnidirectional images based on an actual image support only rotary motion. Accordingly, a study on a field such as acquisition, reproduction technology, etc. of a 6DoF omnidirectional image is actively under way.

### DISCLOSURE

### Technical Problem

The present disclosure is to provide a method for encoding/decoding a spherical harmonic function.

The present disclosure is to provide a method for encoding/decoding coefficients of a spherical harmonic function based on multi-layer structure images.

The technical objects to be achieved by the present disclosure are not limited to the above-described technical objects, and other technical objects which are not described herein will be clearly understood by those skilled in the pertinent art from the following description.

### Technical Solution

An image encoding method according to the present disclosure may include deriving coefficients of a spherical harmonic function for a plurality of vertices on a three-dimensional space; generating a plurality of layer images based on the coefficients; and encoding the plurality of layer images. In this case, each of the plurality of layer images may include a coefficient value in order corresponding to the spherical harmonic function.

In an image encoding method according to the present disclosure, vertices on the three-dimensional space may form a plurality of reference planes and the plurality of layer images may correspond to one of the plurality of reference planes.

In an image encoding method according to the present disclosure, the resolution of each of the plurality of layer images may be the same as the size of an array of vertices included in a corresponding reference plane.

In an image encoding method according to the present disclosure, a transparency image including a transparency value of vertices included in a reference plane may be additionally generated.

In an image encoding method according to the present disclosure, the number of layer images for the reference plane may correspond to the number of coefficients and the number of transparency images for the reference plane may be 1.

In an image encoding method according to the present disclosure, as many transparency images as the number of layer images may be generated.

In an image encoding method according to the present disclosure, at least one of the position or size of a valid region may be different between the transparency images.

In an image encoding method according to the present disclosure, the attribute of each of the plurality of layer images may be designated as a texture.

In an image encoding method according to the present disclosure, the attribute of a first layer image including a first coefficient value among the plurality of layer images may be different from the attribute of a second layer image including a coefficient value other than a first coefficient.

In an image encoding method according to the present disclosure, metadata including directional image configuration information may be additionally encoded.

In an image encoding method according to the present disclosure, the directional image configuration information may include at least one of information on the number of layer images or information on the number of coefficients.

In an image encoding method according to the present disclosure, the directional image configuration information may include basis function information for the spherical harmonic function.

In an image encoding method according to the present disclosure, the directional image configuration information may include interval information between reference planes.

An image decoding method according to the present disclosure may include decoding a plurality of layer images; and reconstructing a target scene based on the decoded layer images. In this case, based on the decoded layer images, coefficients of a spherical harmonic function for a plurality of vertices on a three-dimensional space may be reconstructed and each of the plurality of layer images may include a coefficient value in order corresponding to the spherical harmonic function.

According to the present disclosure, a computer readable recording medium recording instructions for executing an image encoding method/an image decoding method may be provided.

The technical objects to be achieved by the present disclosure are not limited to the above-described technical objects, and other technical objects which are not described herein will be clearly understood by those skilled in the pertinent art from the following description.

### Technical Effect

According to the present disclosure, it is possible to improve image quality by enabling texture representation that considers reflected light based on a spherical harmonic function.

According to the present disclosure, it is possible to reduce the amount of data that must be encoded/decoded by selecting a position where information about a spherical harmonic function is encoded/decoded.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a block diagram of an immersive video processing device according to an embodiment of the present disclosure.

FIG. 2 is a block diagram of an immersive video output device according to an embodiment of the present disclosure.

FIG. 3 is a flow chart of an immersive video processing method.

FIG. 4 is a flow chart of an atlas encoding process.

FIG. 5 is a flow chart of an immersive video output method.

FIG. 6 represents a plurality of images captured by using cameras with a different view.

FIG. 7 represents a method of removing redundant data between a plurality of view images.

FIG. 8 shows an example in which an object in a three-dimensional space is captured through a plurality of cameras at a different position.

FIG. 9 shows a unit grid.

FIG. 10 represents an example in which a target space is expressed as a three-dimensional grid cluster structure.

FIG. 11 represents an example in which the directional information of a voxel is expressed as a multi-layer structure.

FIG. 12 represents a process in which the color information of a vertex is rasterized into a viewport image when the size of vertices positioned on a three-dimensional space is different from each other.

FIG. 13 represents a process of encoding/decoding attribute information of a vertex (i.e., Gaussian).

FIG. 14 represents an example in which a three-dimensional scene representation method is extended to a time axis.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive video, when a user's viewing position is changed, refers to a video that a viewport image may be also dynamically changed. In order to implement an immersive video, a plurality of input images is required. Each of a plurality of input images may be referred to as a source image or a view image. A different view index may be assigned to each view image.

An immersive video may be classified into 3DoF (Degree of Freedom), 3DoF+, Windowed-6DoF or 6DoF type, etc. A 3DoF-based immersive video may be implemented by using only a texture image. On the other hand, in order to render an immersive video including depth information such as 3DoF+ or 6DoF, etc., a depth image (or, a depth map) as well as a texture image is also required.

It is assumed that the embodiments described below are for immersive video processing including depth information such as 3DoF+ and/or 6DoF, etc. In addition, it is assumed that a view image is configured with a texture image and a depth image.

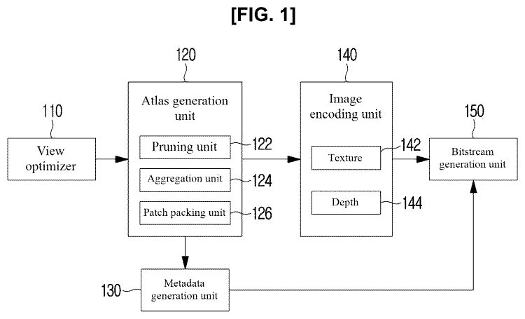

FIG. 1 is a block diagram of an immersive video processing device according to an embodiment of the present disclosure.

In reference to FIG. 1, an immersive video processing device according to the present disclosure may include a view optimizer 110, an atlas generation unit 120, a metadata generation unit 130, an image encoding unit 140, and a bitstream generation unit 150.

An immersive video processing device receives a plurality of pairs of images, intrinsic camera parameters and extrinsic camera parameters as input data to encode an immersive video. Here, a plurality of pairs of images includes a texture image (Attribute component) and a depth image (Geometry component). Each pair may have a different view. Accordingly, a pair of input images may be referred to as a view image. Each of the view images may be divided by an index. In this case, an index assigned to each view image may be referred to as a view or a view index.

Intrinsic camera parameters includes a focal distance, a position of a principal point, etc. and extrinsic camera parameters include translations, rotations, etc. of a camera. Intrinsic camera parameters and extrinsic camera parameters may be treated as a camera parameter or a view parameter.

A view optimizer 110 partitions view images into a plurality of groups. As view images are partitioned into a plurality of groups, independent encoding processing per each group may be performed. In an example, view images captured by N spatially consecutive cameras may be classified into one group. Thereby, view images that depth information is relatively coherent may be put in one group and accordingly, rendering quality may be improved.

In addition, by removing the dependence of information between groups, a spatial random access service which performs rendering by selectively bringing only information in a region that a user is watching may be made available.

Whether view images will be partitioned into a plurality of groups may be optional.

In addition, a view optimizer 110 may classify view images into a basic image and an additional image. A basic image represents an image which is not pruned as a view image with the highest pruning priority and an additional image represents a view image with a pruning priority lower than a basic image.

A view optimizer 110 may determine at least one of the view images as a basic image. A view image which is not selected as a basic image may be classified as an additional image.

A view optimizer 110 may determine a basic image by considering the view position of a view image. In an example, a view image whose view position is the center among a plurality of view images may be selected as a basic image.

Alternatively, a view optimizer 110 may select a basic image based on camera parameters. Specifically, a view optimizer 110 may select a basic image based on at least one of a camera index, a priority between cameras, the position of a camera, or whether it is a camera in a region of interest.

In an example, at least one of a view image with the smallest camera index, a view image with the largest camera index, a view image with the same camera index as a predefined value, a view image captured by a camera with the highest priority, a view image captured by a camera with the lowest priority, a view image captured by a camera at a predefined position (e.g., a central position) or a view image captured by a camera in a region of interest may be determined as a basic image.

Alternatively, a view optimizer 110 may determine a basic image based on the quality of view images. In an example, a view image with the highest quality among view images may be determined as a basic image.

Alternatively, a view optimizer 110 may determine a basic image by considering an overlapping data rate of other view images after inspecting a degree of data redundancy between view images. In an example, a view image with the highest overlapping data rate with other view images or a view image with the lowest overlapping data rate with other view images may be determined as a basic image.

A plurality of view images may be also configured as a basic image.

An Atlas generation unit 120 performs pruning and generates a pruning mask. And, it extracts a patch by using a pruning mask and generates an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124, and a patch packing unit 126.

A pruning unit 122 performs pruning for an additional image based on a pruning priority. Specifically, pruning for an additional image may be performed by using a reference image with a higher pruning priority than an additional image.

A reference image includes a basic image. In addition, according to the pruning priority of an additional image, a reference image may further include other additional image.

Whether an additional image may be used as a reference image may be selectively determined. In an example, when an additional image is configured not to be used as a reference image, only a basic image may be configured as a reference image.

On the other hand, when an additional image is configured to be used as a reference image, a basic image and other additional image with a higher pruning priority than an additional image may be configured as a reference image.

Through a pruning process, redundant data between an additional image and a reference image may be removed. Specifically, through a warping process based on a depth image, data overlapped with a reference image may be removed in an additional image. In an example, when a depth value between an additional image and a reference image is compared and that difference is equal to or less than a threshold value, it may be determined that a corresponding pixel is redundant data.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

While a non-overlapping region may have a non-square shape, a patch is limited to a square shape. Accordingly, a patch may include an invalid region as well as a valid region. Here, a valid region refers to a region composed of non-overlapping pixels between an additional image and a reference image. In other words, a valid region represents a region that includes data which is included in an additional image, but is not included in a reference image. An invalid region refers to a region composed of overlapping pixels between an additional image and a reference image. A pixel/data included by a valid region may be referred to as a valid pixel/valid data and a pixel/data included by an invalid region may be referred to as an invalid pixel/invalid data.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of the shape of a valid region, a patch is extracted in a square shape, so a patch extracted from a square valid region may include invalid data as well as valid data.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map, or a Perspective Projection Format.

Here, an unpruned view image refers to a basic image with the highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 packs a patch in a rectangle image. In patch packing, deformation such as size transform, rotation, or flip, etc. of a patch may be accompanied. An image that patches are packed may be defined as an atlas.

Specifically, packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of the arrangement structures of a camera rig, the accuracy of a depth map, or the number of view images.

A metadata generation unit 130 generates metadata for image synthesis. Metadata may include at least one of camera-related data, pruning-related data, atlas-related data, or patch-related data.

Pruning-related data includes information for determining a pruning priority between view images. In an example, at least one of the flag representing whether a view image is a root node or a flag representing whether a view image is a leaf node may be encoded. A root node represents a view image with the highest pruning priority (i.e., a basic image) and a leaf node represents a view image with the lowest pruning priority.

When a view image is not a root node, a parent node index may be additionally encoded. A parent node index may represent an image index of a view image, a parent node.

Alternatively, when a view image is not a leaf node, a child node index may be additionally encoded. A child node index may represent an image index of a view image, a child node.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

An immersive video output device may restore a reduced depth atlas to its original size after decoding information on a reduction ratio of a depth atlas.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

An image encoding unit 140 encodes an atlas. When view images are classified into a plurality of groups, an atlas may be generated per group. Accordingly, image encoding may be performed independently per group.

An image encoding unit 140 may include a texture image encoding unit 142 encoding a texture atlas and a depth image encoding unit 144 encoding a depth atlas.

A bitstream generation unit 150 generates a bitstream based on encoded image data and metadata. A generated bitstream may be transmitted to an immersive video output device.

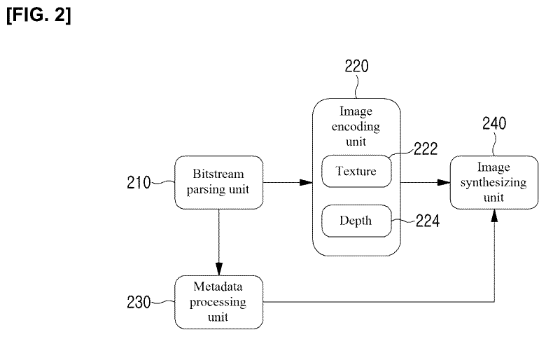

FIG. 2 is a block diagram of an immersive video output device according to an embodiment of the present disclosure.

In reference to FIG. 2, an immersive video output device according to the present disclosure may include a bitstream parsing unit 210, an image decoding unit 220, a metadata processing unit 230 and an image synthesizing unit 240.

A bitstream parsing unit 210 parses image data and metadata from a bitstream. Image data may include data of an encoded atlas. When a spatial random access service is supported, only a partial bitstream including a watching position of a user may be received.

An image decoding unit 220 decodes parsed image data. An image decoding unit 220 may include a texture image decoding unit 222 for decoding a texture atlas and a depth image decoding unit 224 for decoding a depth atlas.

A metadata processing unit 230 unformats parsed metadata.

Unformatted metadata may be used to synthesize a specific view image. In an example, when motion information of a user is input to an immersive video output device, a metadata processing unit 230 may determine an atlas necessary for image synthesis and patches necessary for image synthesis and/or a position/a size of the patches in an atlas and others to reproduce a viewport image according to a user's motion.

An image synthesizing unit 240 may dynamically synthesize a viewport image according to a user's motion. Specifically, an image synthesizing unit 240 may extract patches required to synthesize a viewport image from an atlas by using information determined in a metadata processing unit 230 according to a user's motion. Specifically, a viewport image may be generated by extracting patches extracted from an atlas including information of a view image required to synthesize a viewport image and the view image in the atlas and synthesizing extracted patches.

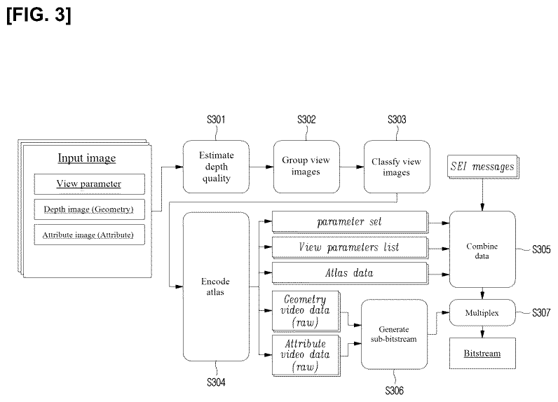

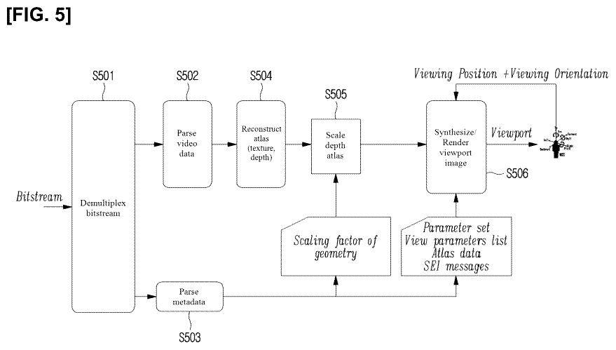

FIGS. 3 and 5 show a flow chart of an immersive video processing method and an immersive video output method, respectively.

In the following flow charts, what is italicized or underlined represents input or output data for performing each step. In addition, in the following flow charts, an arrow represents processing order of each step. In this case, steps without an arrow indicate that temporal order between corresponding steps is not determined or that corresponding steps may be processed in parallel. In addition, it is also possible to process or output an immersive video in order different from that shown in the following flow charts.

An immersive video processing device may receive at least one of a plurality of input images, a camera internal variable and a camera external variable and evaluate depth map quality through input data S301. Here, an input image may be configured with a pair of a texture image (Attribute component) and a depth image (Geometry component).

An immersive video processing device may classify input images into a plurality of groups based on positional proximity of a plurality of cameras S302. By classifying input images into a plurality of groups, pruning and encoding may be performed independently between adjacent cameras whose depth value is relatively coherent. In addition, through the process, a spatial random access service that rendering is performed by using only information of a region a user is watching may be enabled.

But, the above-described S301 and S302 are just an optional procedure and this process is not necessarily performed.

When input images are classified into a plurality of groups, procedures which will be described below may be performed independently per group.

An immersive video processing device may determine a pruning priority of view images S303. Specifically, view images may be classified into a basic image and an additional image and a pruning priority between additional images may be configured.

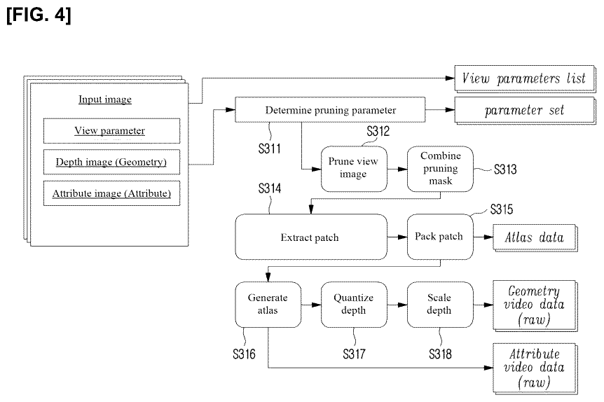

Subsequently, based on a pruning priority, an atlas may be generated and a generated atlas may be encoded S304. A process of encoding atlases is shown in detail in FIG. 4.

Specifically, a pruning parameter (e.g., a pruning priority, etc.) may be determined S311 and based on a determined pruning parameter, pruning may be performed for view images S312. As a result of pruning, a basic image with a highest priority is maintained as it is originally. On the other hand, through pruning for an additional image, overlapping data between an additional image and a reference image is removed. Through a warping process based on a depth image, overlapping data between an additional image and a reference image may be removed.

As a result of pruning, a pruning mask may be generated. If a pruning mask is generated, a pruning mask is combined in a unit of an intra-period S313. And, a patch may be extracted from a texture image and a depth image by using a combined pruning mask S314. Specifically, a combined pruning mask may be masked to texture images and depth images to extract a patch.

In this case, for an non-pruned view image (e.g., a basic image), a whole view image may be treated as one patch.

Subsequently, extracted patches may be packed S315 and an atlas may be generated S316. Specifically, a texture atlas and a depth atlas may be generated.

In addition, an immersive video processing device may determine a threshold value for determining whether a pixel is valid or invalid based on a depth atlas S317. In an example, a pixel that a value in an atlas is smaller than a threshold value may correspond to an invalid pixel and a pixel that a value is equal to or greater than a threshold value may correspond to a valid pixel. A threshold value may be determined in a unit of an image or may be determined in a unit of a patch.

For reducing the amount of data, a size of a depth atlas may be reduced by a specific ratio S318. When a size of a depth atlas is reduced, information on a reduction ratio of a depth atlas (e.g., a scaling factor) may be encoded. In an immersive video output device, a reduced depth atlas may be restored to its original size through a scaling factor and a size of a texture atlas.

Metadata generated in an atlas encoding process (e.g., a parameter set, a view parameter list or atlas data, etc.) and SEI (Supplemental Enhancement Information) are combined S305. In addition, a sub bitstream may be generated by encoding a texture atlas and a depth atlas respectively S306. And, a single bitstream may be generated by multiplexing encoded metadata and an encoded atlas S307.

An immersive video output device demultiplexes a bitstream received from an immersive video processing device S501. As a result, video data, i.e., atlas data and metadata may be extracted respectively S502 and S503.

An immersive video output device may restore an atlas based on parsed video data S504. In this case, when a depth atlas is reduced at a specific ratio, a depth atlas may be scaled to its original size by acquiring related information from metadata S505.

When a user's motion occurs, based on metadata, an atlas required to synthesize a viewport image according to a user's motion may be determined and patches included in the atlas may be extracted. A viewport image may be generated and rendered S506. In this case, in order to synthesize viewpoint image with the patches, size/position information of each patch and a camera parameter, etc. may be used.

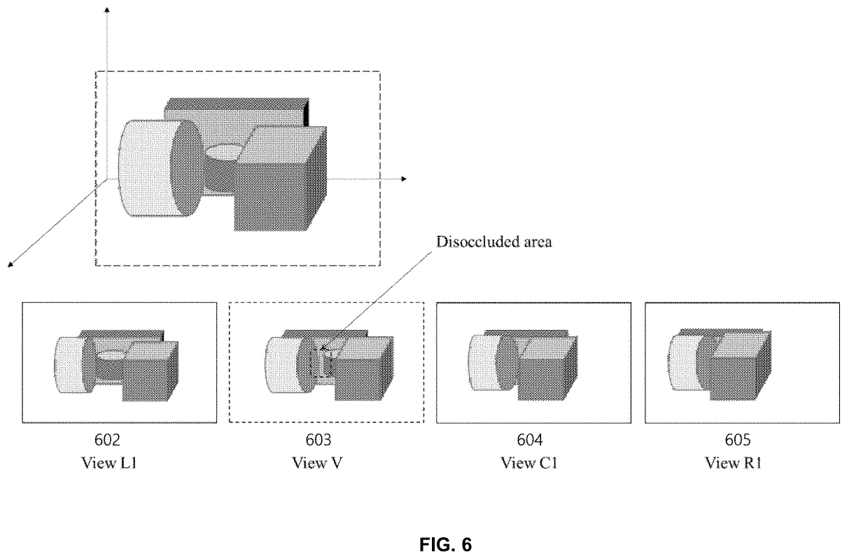

FIG. 6 represents a plurality of images captured by using cameras with a different view.

When ViewC1 604 is referred to as a central view, ViewL1 602 and ViewR1 605 represent a left view image of a central view and a right view image of a central view, respectively.

When a virtual view image ViewV 603 between a central view ViewC1 and a left view image ViewL1 is generated, there may be a region which is hidden in a central view image ViewC1, but is visible in a left view image ViewL1. Accordingly, image synthesis for a virtual view image ViewV may be performed by referring to a left view image ViewL1 as well as a central view image ViewC1.

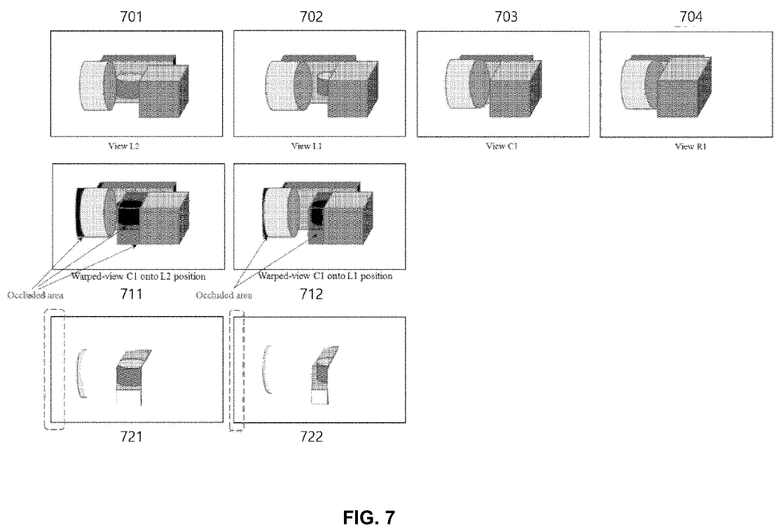

FIG. 7 represents a method of removing redundant data between a plurality of view images.

A basic view among a plurality of view images is selected and for non-basic view images, redundant data with a basic view is removed. In an example, when a central view ViewC1 is referred to as a basic view, remaining views excluding ViewC1 become an additional view used as a reference image in synthesis. All pixels of a basic view image may be mapped to a position of an additional view image by using a three-dimensional geometric relationship and depth information (depth map) of each view image. In this case, mapping may be performed through a 3D view warping process.

In an example, as in an example shown in FIG. 7, a basic view image ViewC1 may be mapped to a position of a first left view image ViewL1 702 to generate a first warped image 712 and a basic view image ViewC1 may be mapped to a position of a second left view image ViewL2 701 to generate a second warped image 711.

In this case, a region which is invisible due to observation parallax in a basic view image ViewC1 is processed as a hole region without data in an warped image. A region where data (i.e., a color) exists except for a hole region may be a region which is also visible in a basic view image ViewC1.

A pruning process for removing an overlapped pixel may be performed through a procedure for confirming whether an overlapped pixel between a basic view and an additional view may be determined as redundancy. In an example, as in an example shown in FIG. 7, a first residual image 722 may be generated through pruning between a first warped image and a first left view image and a second residual image 721 may be generated through pruning between a second warped image and a second left view image. By reducing image data through a pruning process, compression efficiency may be improved in encoding an image.

Meanwhile, a determination on an overlapped pixel may be based on whether at least one of a color value difference and/or a depth value difference for pixels at the same position is smaller than a threshold. In an example, when at least one of a color value difference and a depth value difference is smaller than a threshold, both pixels may be determined to be overlapped pixels.

In this case, a case may occur in which they are determined to be an overlapped pixel although they are not an overlapped pixel due to a problem such as a color or a depth value noise in an image, an error in a camera calibration value or an error in a decision equation. In addition, a case may also occur in which a color value is different depending on the position of a camera used to capture the pixel due to a characteristic of a reflective surface of various materials in a scene and a source of light even between pixels at the same position. Accordingly, although a pruning process is very accurate, information expressing a scene may be lost, which may cause image quality deterioration when rendering a target view image in a decoder.

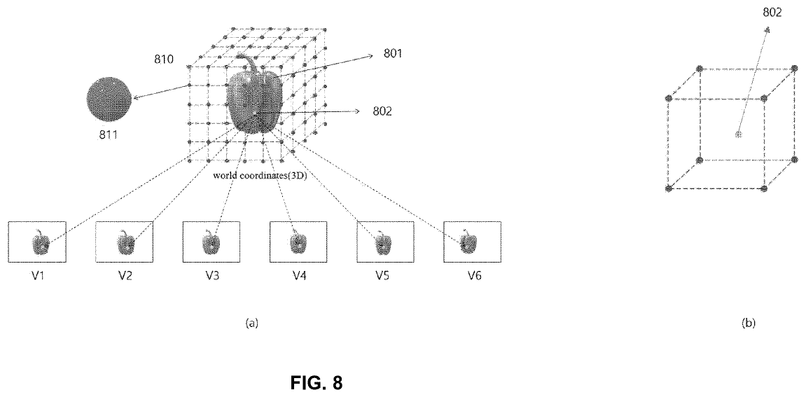

FIG. 8 shows an example in which an object in a three-dimensional space is captured through a plurality of cameras at a different position.

In FIG. 8(a), it is assumed that each image is projected into a two-dimensional image.

In FIG. 8(a), V1 to V6 represent view images captured by cameras having a different capturing angle (pose). As in a shown example, according to a capturing angle (pose) and a position of a camera acquiring an object, even the same point in a three-dimensional space may have a different aspect of being projected into a two-dimensional image. In an example, when an any one point 802 on an object is projected on each of view images V1 to V6, according to a camera capturing angle (pose), a pixel value corresponding to the any one point 802 in a projected two-dimensional image may be not the same, but different between corrective images.

Similarly, object 801 shown in FIG. 8(a) may also have different brightness per view due to a characteristic of a reflective surface and a light source.

However, when pixels corresponding to any one point 802 on an object in view images are determined to be an overlapped pixel, through a pruning process, a pixel in a basic view image is maintained and a pixel in an additional view image is removed. In other words, although pixels corresponding to any one point 802 on an object in view images have different brightness, if a difference in depth values (or color values) is less than or equal to a threshold value, they are determined as an overlapped pixel.

A pruning process removes data redundancy to improve data compression efficiency, but as in the example, determines pixels with different brightness as an overlapped pixel to cause a loss in information quantity, resulting in image quality deterioration in rendering in a decoder. In particular, a color value on a surface such as a mirror that an incident light source is totally reflected or a transparent object that an incident light source is refracted, not a diffused reflection surface, may be determined as an overlapping pixel and removed in a pruning process although a color value is totally different according to an angle.

In order to reconstruct a color value of a real mixed reflective surface which looks different according to an observer's viewing position and angle, it is required to have information for all viewing angles as well as a specific angle or a method of modeling a reflective characteristic of a mixed reflective surface may be considered. Hereinafter, a method of modeling a reflective characteristic of a mixed reflective surface is described in detail.

Meanwhile, the above-described embodiments relate to data compression of an immersive video. In other words, embodiments shown in FIGS. 1 to 7 aim to reconstruct an image for a three-dimensional space based on a decoded immersive image after decoding an encoded immersive image.

Recently, a discussion on deep learning-based image processing methods has also been actively conducted. As an example, instead of depth map-based rendering used traditionally, a technology that receives a plurality of images for a target scene or a target three-dimensional space as an input and models a radiance field is in the spotlight. Here, modeling of a radiance field or Gaussian splats may be performed by inputting a plurality of images into a neural network.

Meanwhile, a radiance field represents a function or a data structure that represents the characteristic of light for all points in a three-dimensional space. As an example, the characteristic of light may represent how incident light is reflected when passing through each point.

A technology for modeling a radiance field in a three-dimensional space may be called Neural Radiance Field (NeRF).

When using NeRF, it is possible to more realistically reconstruct a non-Lambertian region, etc. which may not be expressed by using a traditional image synthesis method. In addition, the existing complex equations or algorithms may be replaced with a deep learning process, i.e., a neural network learning process.

In addition to NeRF, explicit feature information may also be utilized. Specifically, a scene on a target space may be expressed in a form such as a voxel grid, and feature information that may express a voxel grid may be calculated through a model training process.

As an example, FIG. 8(a) shows an example in which a three-dimensional region of interest to which an object in a target scene belongs is expressed in a three-dimensional grid structure. In an example shown in FIG. 8(a), it was illustrated that a space including an object 801 is expressed in a three-dimensional grid structure expressed by a world coordinate system. Here, a three-dimensional grid structure means a cluster where three-dimensional vertices are arranged at an equal interval, and as an example, sign 811 approximates one of the three-dimensional vertices in a sphere shape. As in an example shown in FIG. 8(b), any point 802 represents a three-dimensional vertex corresponding to any intermediate position in a three-dimensional grid structure. Meanwhile, a hexagon defined by a plurality of vertices may be called a voxel.

When a target space is configured with three-dimensional grids in a unit of a voxel, a feature vector that may embody color information and density information of a corresponding region may be allocated to each vertex that configures a voxel.

A feature vector for a three-dimensional point at any position in a three-dimensional space may be calculated by trilinear interpolating feature vectors of neighboring vertices (e.g., 8 vertices configuring a voxel that includes a point at any position). In other words, color and density information for a three-dimensional point at any position may be obtained through the tri-linear interpolation of feature vectors of neighboring vertices.

The NeRF technology using explicit feature information must express a target space with a three-dimensional grid, which causes an increase in data capacity. Due to an increase in data capacity, restrictions on model file storage and inference may occur. Accordingly, a structure that encodes/decodes feature information of a target space may be considered by utilizing a server-client model.

In other words, embodiments described below may be used not only for encoding/decoding an immersive image, but also for encoding/decoding feature information of a target space.

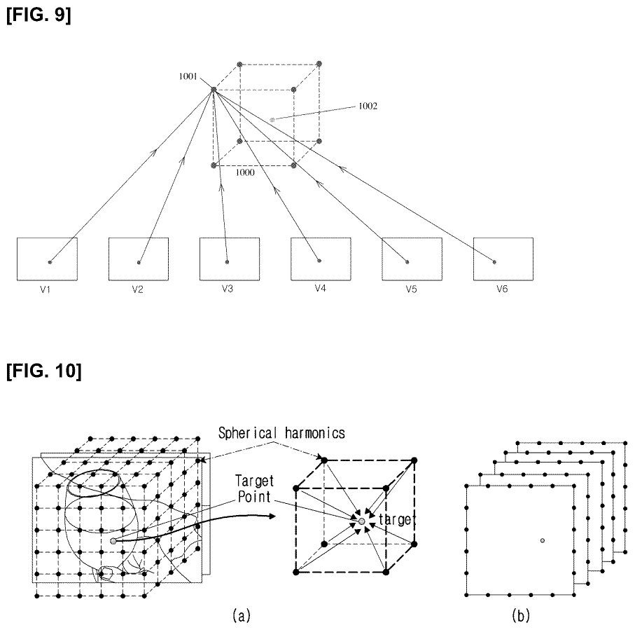

FIG. 9 shows a unit grid.

In FIG. 9, it was shown that unprojection is performed in the form of a ray on a vertex 1001 configuring a unit grid from the pixel of each viewpoint image (V1 to V6). As in a shown example, camera calibration information corresponding to a viewpoint image may be used to perform unprojection in the form of a ray on a vertex 1001 configuring a unit grid from the pixel of a viewpoint image. In this case, when the color value of a ray projected on a vertex 1001 from each viewpoint image is referenced, the color value of a vertex 1001 for any viewpoint may be estimated.

Furthermore, when the color value of the eight vertices configuring a grid 1000 may be estimated by referring to pixels in viewpoint images (V1 to V6), at least one of a color value, a brightness value or an opacity value for any point 1002 in a grid may also be estimated. In other words, eight vertices configuring a grid may be used as reference vertices to estimate information on a target point 1002 in a grid by using a method such as the three-dimensional linear interpolation (tri-linear interpolation), average or weighted operation of reference vertices.

Meanwhile, in an example shown in FIG. 8, each reference point defining a voxel may be expanded into a form having a three-dimensional volume. As an example, it may be defined as a three-dimensional shape such as a sphere or an ellipsoid centered on a vertex. For this, size information of each vertex configuring a grid may be required.

Here, when the size (scaling) of each vertex configuring a grid is the same, information on a target point may be estimated by a simple method such as three-dimensional linear interpolation, etc. On the other hand, when the size of vertices configuring a grid is different from each other, a size component may be modeled as an additional parameter so that an occupied area (or space) when color and intensity information of a ray for a vertex projected on a viewport image is rasterized may be variable when a vertex 1001 is projected on a target viewpoint. Through this, parameters for representing the target scene may be optimized.

In other words, based on size information, occupancy at a position where it is projected on a viewport image and rasterized may be set as a weight, and information about a target point 1001 may be estimated through the weighted operation of vertices configuring a voxel.

Meanwhile, size information may basically represent the radius of a circle or a sphere. In this case, for a vertex existing on a three-dimensional space, a radius for each of a x-axis, a y-axis and a z-axis may be individually set. When a radius for at least one of a x-axis, a y-axis and a z-axis is different from other axes, it shows that the shape of a vertex is an ellipsoid. The method may be applied to a three-dimensional grid cluster to reconstruct a target object for any viewpoint. Meanwhile, as an interval between vertices configuring a three-dimensional grid cluster surrounding a target object is closer, a target object may be reconstructed with higher resolution.

In order to reconstruct a target object by using the method, a color value according to the incident angle (i.e., shooting angle) of a ray unprojected from each camera must be known for all reference vertices configuring a three-dimensional grid cluster for a target object.

Meanwhile, the number of lines passing through a reference vertex in the form of a ray may be variable by at least one of the number of cameras (i.e., viewpoint images), the resolution of an image or a camera geometric structure.

The more diverse the angles of rays incident from cameras (i.e., viewpoint images) to a reference vertex, the more accurately the color values by incident angle or direction of a target point may be reconstructed. In other words, as more reflected light information shows information when a light source reflected from a target point is projected onto each camera (i.e., each viewpoint image) (i.e., as the reflected light information of a light source is obtained at various angles), a target point may be reconstructed realistically at various viewpoints and directions.

As in an example shown in FIG. 8(a), when a reference vertex is assumed to have the shape of a sphere 811 with a radius of r, a color value at the moment when a ray is reflected while passing through a corresponding reference vertex may be stored as reflected light information. Meanwhile, the reflected light information may be stored for each incident angle (direction) of a ray.

Reflected light information may be utilized to reconstruct an appropriate color according to an angle at which a corresponding reference vertex is observed when synthesizing an image at any viewpoint.

Meanwhile, when a reference vertex is assumed to have the shape of a sphere, the distribution of the reflected light intensity on a sphere may be approximated based on a neighboring value through Laplace's equation in the spherical coordinate system (spherical coordinates) in the shape of a sphere. As an example, the distribution of reflected light intensity may be approximated by using a spherical harmonic function (spherical harmonics).

Equation 1 below represents a spherical harmonic function.

$$[ Equation 1 ]$$

$${Y}_{l , m} ( θ , ϕ ) = \{ \begin{matrix}\text{?} {P}_{l}^{\vert m \vert} ( cos θ ) sin ( \vert m \vert ϕ ) & - l \leq m \leq 0 \\ \frac{{c}_{l , m}}{\sqrt{2}} {P}_{l}^{0} ( cos θ ) & m = 0 \\ {c}_{l , m} , {P}_{l}^{m} ( cos θ ) cos ( m ϕ ) & 0 \leq m \leq l\end{matrix}$$

$$\text{?} \text{indicates text missing or illegible when filed}$$

In Equation 1, Y_{I,m} represents a spherical harmonic function. θ is an angle with a z-axis in a positive direction in a spherical coordinate system, and φ is an angle with a x-axis in a positive direction with a z-axis as an axis. Since a function is continuous, I is a non-negative integer, and m is an integer satisfying -I≤m≤I.

In Equation 1, C_{I,m} may be derived according to Equation 2 below.

$${c}_{l , m} = \sqrt{\frac{2 l + 1}{2 π} \frac{( l + \vert m \vert ! )}{( l + \vert m \vert ! )}} \qquad [ Equation 2 ]$$

In addition, in Equation 1, Pᵢ^{m} represents Legendre Polynomials.

When a spherical harmonic function that approximates the distribution of reflected light components at a spherical target point is called [symbol] , [symbol] may be represented as the weighted sum of spherical harmonic functions (basis functions) Y_{I,m} of reference vertices as in Equation 3 below.

$$\tilde{f} ( θ , ϕ ) = {\sum }_{l , m} {c}_{lm} {Y}_{lm} ( θ , ϕ ) \qquad [ Equation 3 ]$$

As the order of a spherical harmonic function increases, reflected light component information corresponding to a local region on a spherical coordinate system may be approximated by distinguishing it from other regions. In other words, as the order of a spherical harmonic function increases, the high-frequency component of reflected light expressed in a local region on a spherical coordinate system is included.

The intensity by orientation of reflected light component information that may be expressed by a corresponding sphere may be approximated by referring to the intensity of a ray incident on a spherical target point. Specifically, when the order of a spherical harmonic function is 2, a weight function for a total of 9 basis functions may be calculated to approximate a spherical harmonic function for a target point.

In this case, when there is information on a coefficient corresponding to the weight of a basis function Y_{I,m} in Equation 3, it may be used to approximate a target point and accordingly, reflected light information in any direction may be reconstructed. In order to approximate the intensity of trichromatic circles R, G, B, the weight of a basis function must be calculated by referring to the intensity of each channel individually.

The above-described spherical harmonic function may be applied to a video encoder/decoder structure to reconstruct a pixel value for a target point at any viewpoint. Specifically, in an encoder, the coefficient of basis functions may be stored in an attribute and encoded in an image format or may be encoded in a metadata format and transmitted to a decoder. In a decoder, reflected light information in any direction for a target point may be reconstructed by using a received coefficient. In this case, the minimum size of data for encoding a coefficient may be a value obtained by multiplying the number of vertices configuring a three-dimensional grid cluster by the number of basis functions (the number of coefficients) of a spherical harmonic function as in Equation 4 below.

$$[ Equation 4 ]$$

$$Minimum Metadata size = Number of Elements \times Number of Coefficients \times Date size per Coefficien \text{?}$$

$$\text{?} \text{indicates text missing or illegible when filed}$$

In addition, size information for determining the size of a vertex configuring a three-dimensional grid cluster may also be encoded/decoded together. As an example, the size information may include information showing the radius of a circle or a sphere. Alternatively, the size information may include information showing a radius for each of a x-axis, a y-axis and a z-axis.

Meanwhile, information showing the shape of a vertex may also be additionally encoded/decoded. As an example, when shape information indicates that a vertex is circular or spherical, information showing a radius may be encoded and signaled only for one of a x-axis, a y-axis and a z-axis. On the other hand, when shape information indicates that a vertex is elliptical, information showing a radius may be encoded and signaled for each of a x-axis, a y-axis and a z-axis.

Meanwhile, the position of a vertex must also be encoded/decoded together with a spherical harmonic function. When the position of each vertex is directly encoded/decoded, a large amount of bits are required to encode/decode the position of vertices. In order to reduce the amount of data required to encode the positions of a vertix, vertices may be arranged in a multi-layer format.

FIG. 10 shows an example in which a target space is expressed as a three-dimensional grid cluster structure.

In an example shown in FIG. 10(a), for a voxel unit grid cluster, the opacity and a spherical harmonic function coefficient for all vertices may be obtained according to Equation 5.

Equation 5 shows an equation for deriving the opacity and a color value for N reference points located along a ray, in a process in which a ray is unprojected in the direction of a target scene from each pixel in a plurality of reference viewpoint images. Here, a reference point represents a point through which a ray passes.

$${C}_{R} ( r ) = {\sum }_{i = 1}^{N} {T}_{i} ( 1 - exp ( - {σ}_{i} {δ}_{i} ) ) {c}_{i} \qquad [ Equation 5 ]$$

In Equation 5 above, C_{R}(r) represents the reconstructed color value of an input ray. N represents the number of reference points on a corresponding ray and i represents the index of each reference point. σ represents opacity, δ represents an interval (i.e., an offset) between reference points and c represents a color value. Tᵢ represents the transmittance of a reference point where an index is i. The transmittance Tᵢ of a reference point may be derived as in Equation 6 below.

$${T}_{i} = exp ( - {\sum }_{j = 1}^{i - 1} {σ}_{j} {δ}_{j} ) \qquad [ Equation 6 ]$$

The reference points on a ray processed by Equation 5 may be processed sequentially in order of distances from a camera. In this case, as shown in Equation 6, the i-th reference point may be derived by referring to the accumulated opacity σᵢ and the accumulated interval δᵢ to a previous reference point (i.e., the i-1-th reference point).

In Equation 5, cᵢ represents the color value of the i-th reference point and a corresponding value may vary depending on the direction of a ray. Accordingly, the color value cᵢ of a reference point may be derived based on a spherical harmonic function.

The color C_{R}(r) of a ray reconstructed by Equation 5 may be determined as a value that minimizes a difference with the value of an original viewpoint image (i.e., C(r)). As an example, the optimal color value C_{R}(r) of a reconstructed ray may be obtained through an optimization process by Equations 7 and 8 below.

$${L}_{recon} = \frac{1}{\vert R \vert} {\sum }_{r ∈ R} {‖ C ( r ) - \hat{C} ( r ) ‖}_{2}^{2} \qquad [ Equation 7 ]$$

$$L = {L}_{recon} + λ 0 \qquad [ Equation 8 ]$$

As in an example of Equation 7, for each ray belonging to Set R, a difference between a reconstructed color value C_{R} (r) and the color value C (r) of an original image corresponding thereto may be derived and a loss cost L_{recon} may be derived by averaging difference values for all rays belonging to Set R. Afterwards, after applying a weight λ to an additional loss cost a calculated by an additional constraint, a loss cost L_{recon} and a weighted additional loss cost Aa may be combined to derive the total loss cost L. Among a plurality of viewpoints, based on a viewpoint when the total loss cost L derived from Equation 8 is low, a reconstructed color value C_{R}(r) for all rays may be derived.

When a reconstructed color value C_{R}(r) is derived, the coefficient of a spherical harmonic function and an opacity value at the position of vertices configuring a target scene may be derived.

Meanwhile, opacity may also be called occupancy. The value of opacity or occupancy may represent a probability that incident light will be reflected or transmitted by a particle on a three-dimensional space at each vertex. As an example, when incident light will be highly likely reflected by a particle on a three-dimensional space, it may mean that a corresponding vertex is highly likely positioned on the surface of an object or background. Considering the characteristic, the value of opacity or occupancy may be utilized as a probability value for deriving a distance (i.e., a depth value) between a vertex and a camera by using the geometric information of a target scene (e.g., the camera calibration information of a target scene).

In order to reconstruct a vertex in a target space represented as a three-dimensional grid cluster structure (hereinafter referred to as a target vertex), reference vertices near a target vertex may be used. Specifically, the color value, brightness value or opacity of a target vertex may be obtained through the tri-linear interpolation of the color value, brightness value or opacity of eight vertices of a voxel to which a target vertex belongs.

Meanwhile, a multi-layer structure may be used as a method for representing a three-dimensional grid cluster. Specifically, a plurality of layers are stacked, and in this case, the resolution of each layer may be the same as the number of three-dimensional voxels configuring one plane (or, cross section) of a grid cluster. In this case, when it is assumed that the coordinate of each vertex is defined as x, y, and z coordinates, one plane of a grid cluster may be a set of vertices having the same x-axis coordinate, y-axis coordinate, or z-axis coordinate (refer to FIG. 10(b)). In this case, one plane of a grid cluster may be called a layer plane or a reference plane.

In addition, a spherical harmonic function may be allocated to vertices configuring each voxel and the number of layers for a reference plane may exist as many as the number of coefficients of a spherical harmonic function. As an example, the i-th layer may include the i-th spherical harmonic function coefficient for each vertex in a reference plane.

Meanwhile, when the order of a spherical harmonic function is 0, data to be encoded/decoded has a structure similar to that of general image data. On the other hand, when the order of a spherical harmonic function is greater than or equal to 1, a basis function in more directions may be utilized according to the order and the degree of freedom, and accordingly, directional data for covering multiple directions is required.

In other words, as the order and the degree of freedom increase, directional data that may be expressed increases, and accordingly, the number of layers configuring a reference plane may increase.

Meanwhile, when a multi-layer structure is used, layers may be stacked similarly to a MultiPlane Images (MPI) structure. Specifically, an MPI structure is generated by arranging a plurality of layered images along the z-axis direction within a specific depth range, based on a specific reference viewpoint for a three-dimensional volumetric scene. In this case, a z-axis may represent a depth value and a spacing interval (i.e., a depth value difference) between a plurality of layered images may be constant.

An MPI image is composed of color information and transparency information of each layered image. In this case, color information for a layered image may be obtained by reprojecting a reference viewpoint image onto the plane of a corresponding layer. In addition, transparency information represents the level of transparency of all pixels in a layered image.

In other words, in an MPI structure, a texture image and a transparency image for a layered image may be encoded/decoded, respectively.

In the present disclosure, a method for encoding/decoding the directional information of a voxel is proposed by utilizing an MPI image structure described above.

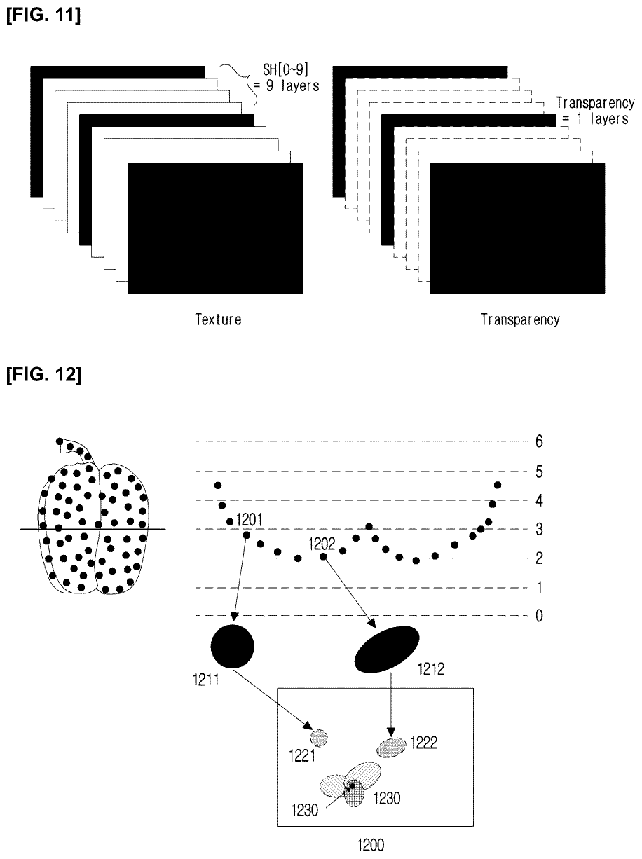

FIG. 11 represents an example in which the directional information of a voxel is expressed as a multi-layer structure.

The directional information of a voxel may be encoded/decoded by using texture images, i.e., texture layers, of an MPI structure.

Since the directional information of a voxel is represented by spherical harmonic function coefficients, texture layers may include information of spherical harmonic function coefficients.

Meanwhile, the number of layers for encoding/decoding the directional information of a voxel may be the same as the number of spherical harmonic function coefficients. As an example, when the number of spherical harmonic function coefficients is 9, the number of texture layers corresponding to one plane (i.e., reference plane) of a grid cluster may be 9.

Meanwhile, as described through Equation 5 above, opacity of a vertex is required to obtain the color information of a vertex. The opacity for all vertices may be set as a transparency layer. Here, opacity and transparency mean the same information, although they are just a different descriptive term.

Meanwhile, for one plane (i.e., reference plane) of a grid cluster, only one transparency layer may exist.

In other words, when the coefficients of a spherical harmonic function are N, the number of texture layers corresponding to a reference plane may be N, while the number of transparency layers may be 1.

However, in an MPI structure, a transparency image is utilized not only for a transparency value, but also for patch masking. Considering this, as many transparency layers as the number of texture layers may be generated.

However, when the number of transparency layers is increased by the number of texture layers, a problem occurs that the amount of data to be encoded/decoded increases.

Accordingly, for efficient memory usage, a plurality of transparency layers may be stored in an asymmetric state and when performing an actual operation, as many reference transparency layers as the number of texture layers may be copied and processed. Here, an asymmetric state means that the number of texture layers and the number of transparency layers are not the same.

Alternatively, a valid region between transparency layers may be set differently. In other words, a target view image is reconstructed by using only data within a valid region within a transparency layer, but the position and/or size of a valid region between transparency layers may be set differently.

Identification information for identifying the attribute of a layer may be encoded/decoded. As an example, a syntax attribute_type_id may be an identifier representing one of a plurality of attributes. A plurality of attributes may include texture and transparency.

Meanwhile, an attribute between a layer including a coefficient with the smallest index among the spherical harmonic function coefficients (i.e., the first coefficient of a spherical harmonic function) and a layer including a coefficient other than a coefficient with the smallest index may be set differently. As an example, the attribute of a layer including a coefficient with the smallest index or a transparency layer corresponding thereto may indicate texture or transparency, while the attribute of a layer including a coefficient other than a coefficient with the smallest index or a transparency layer corresponding thereto may indicate an attribute different from texture or transparency. Here, an attribute different from texture or transparency may be an attribute (e.g., an additional coefficient or additional transparency, etc.) newly defined for a layer including a coefficient other than a coefficient with the smallest index or a transparency layer corresponding thereto.

As described above, when encoding/decoding the directional information of a voxel based on a multi-layer structure, the amount of data to be encoded/decoded increases as the resolution of a layer and the number of coefficients of a spherical harmonic function are larger. As the amount of data increases, an efficient data processing method is required to improve the amount of data processing or algorithm performance.

As described above, each vertex configuring a voxel has color intensity information and transparency information according to a direction through spherical harmonic function coefficients. However, when a target scene is reconstructed, all voxels do not have a significant influence.

Considering this, when an actual target scene is reconstructed, how information held by a voxel has influence may be calculated in advance and then, the amount of data to be encoded/decoded may be reduced for a voxel with small influence. Specifically, the amount of data to be encoded/decoded may be reduced by either pruning (i.e., removing) the information about a voxel with small influence (specifically, vertices configuring the voxel) or by quantizing information about a voxel with small influence (specifically, vertices configuring the voxel).

As another example of processing data representing a three-dimensional volumetric space, only a part of a target space, not the entire region, may be represented using a multi-layer structure. Specifically, the need for directional information when rendering a target three-dimensional space arises from the fact that color may vary depending on the viewer's perspective. In other words, by encoding/decoding viewpoint-dependent information that is dependent on a user's viewpoint, a target three-dimensional space may be rendered according to a user's viewpoint.

However, in diffuse reflection region such as a Lambertian Region, color information by direction (i.e., by viewpoint) does not vary significantly. In other words, storing directional information in a diffuse reflection region may cause the effect of encoding/decoding unnecessary data.

Accordingly, only a part of a three-dimensional space, not the entire region, may be expressed in a multi-layer structure. As an example, only a non-Lambertian region in a three-dimensional space may be expressed in a multi-layer structure, or only residual regions excluding a Lambertian region in a three-dimensional space may be expressed in a multi-layer structure.

Meanwhile, encoding/decoding using a patch may be performed for a region that is not expressed in a multi-layer structure (i.e., a region that is expressed in a single-layer structure). In other words, a patch image (i.e., an atlas) for a region not expressed in a multi-layer structure may be generated and a region not expressed in a multi-layer structure may be reconstructed by encoding/decoding a patch image.

As another example, spherical harmonic function coefficients may be set differently depending on a depth. As an example, when the first cross section of a grid cluster corresponds to a non-Lamtertian region while the second cross section of a grid cluster corresponds to a Lambertian region, the number of spherical harmonic function coefficients for a first cross section may be greater than the coefficient of spherical harmonic functions for a second cross section. Accordingly, the number of texture layers for a first cross section may be greater than the number of texture layers for a second cross section. As an example, a first cross section may be expressed by a plurality of texture layers, while a second cross section may be expressed by a single texture layer or a smaller number of texture layers than a first cross section.

A multi-layer structure is generated by converting the attribute of voxels into an image format and arranging/packing converted images in a depth direction. Meanwhile, a multi-layer structure may be encoded/decoded based on a general video codec (e.g., AVC, HEVC, VVC, VP9, or AV1, etc.).

Meanwhile, an attribute for storing a value that may represent the attribute of voxels, not the coefficient value of a spherical harmonic function, may be additionally defined. As an example, when the attribute of a layer is represented as a feature map, a layer may be represented in the form of a feature vector which is mainly used in scene representation in NeRF.

After generating a directional image in a multi-layer structure proposed in the present disclosure, in order to encode/decode it, the directional image configuration information of a multi-layer structure may be additionally encoded/decoded. Here, directional image configuration information may include at least one of the total number of layers, the resolution (i.e., a width and/or a height) of a layer image or a reference plane, the depth information of a reference plane, an interval between reference planes (calculated based on at least one of a x-axis, a y-axis or a z-axis), the number information of spherical harmonic function coefficients of each voxel or each layer plane, basis function information, the camera calibration information of reference image(s) or camera calibration information for a reference viewpoint position. Here, basis function information may be necessary for reconstructing color information and/or transparency information based on spherical harmonic function coefficients. In addition, a reference image may represent an image used for configuring the directional image of a multi-layer structure. Meanwhile, the directional image configuration information of a multi-layer structure may be encoded/decoded as metadata.

A receiving terminal may receive and decode the directional image configuration information of a multi-layer structure to reconstruct a target viewpoint image.

In an example shown in FIG. 8, when it is assumed that each reference vertex is a sphere with a size of radius r, a target point on a three-dimensional space may also be considered as a sphere with a size of radius r. In other words, through a spherical harmonic function coefficient, spherical directional color information for a target vertex may be derived.

Meanwhile, in the above-described embodiments, it was assumed that size information on the size of all vertices (i.e., radius r) was the same. However, in the process of synthesizing a target three-dimensional scene, the sizes of vertices may be changed.

FIG. 12 represents a process in which the color information of a vertex is rasterized into a viewport image when the sizes of vertices positioned on a three-dimensional space is different from each other.

In a process in which vertices are projected onto a target viewpoint image and synthesized, the color information of a vertex may be rasterized into a target viewpoint image.

Specifically, in FIG. 12, it was illustrated that a first vertex 1201 is a sphere 1211 with a radius of r. On the other hand, it was illustrated that a second vertex 1202 is an ellipsoid that the radius for each of a x-axis, a y-axis and a z-axis is set individually.

A three-dimensional sphere 1211 may be modeled through color information (e.g., a spherical harmonic function coefficient) and size information for each direction held by a first vertex 1201. Similarly, a second vertex 1202 may be modeled as an ellipsoid 1212 through color information and size information for each direction held by a second vertex 1202. Meanwhile, for an ellipsoid, not only size information for each axis, but also rotation information for each axis may be set. Accordingly, an ellipsoid may be modeled so that each axis faces a different direction (orientation).

A sphere 1211 and an ellipsoid 1212 geometrically model the probability distribution within the three-dimensional shape (e.g., within a range set by a radius of r) of directional color intensity information (e.g., a spherical harmonic function coefficient) corresponding to each direction (azimuth) based on the center of a three-dimensional shape.

When the probability distribution follows Gaussian distribution, the distribution of a corresponding structure may be defined by Equation 9 below.

$$G ( x ) = {e}^{- \frac{1}{2} {( x )}^{{T}_{\sum } - 1} ( x )} \qquad [ Equation 9 ]$$

In Equation 9 above, Σ represents a three-dimensional covariance matrix for Gaussian distribution in a three-dimensional shape.

When a three-dimensional Gaussian such as a sphere 1211 and an ellipsoid 1212 is projected onto the target viewport image 1200, it is rasterized to form a two-dimensional circular shape (1221) and a two-dimensional elliptical shape (1222), respectively,

In other words, the color intensity information of a ray radiating from the center of a three-dimensional shape is modeled into a three-dimensional Gaussian such as a sphere 1211 or an ellipsoid 1212 according to the Gaussian probability distribution with reference to size information and rotation information. In addition, when a three-dimensional Gaussian is projected onto a target two-dimensional image 1200, it may be rasterized into a two-dimensional circle or a two-dimensional ellipse and a target viewpoint image may be synthesized.

When a different Gaussian is projected onto the same position, the value of a pixel within a corresponding overlapping region 1230 may be derived through a weighted sum operation using the occupancy information (or opacity) of Gaussians projected onto the same position as a weight.

$${\sum }^{′} = JW \sum {W}^{T} {J}^{T} \qquad [ Equation 10 ]$$

Equation 10 above shows a process in which a covariance matrix Σ′ in a camera coordinate system is calculated when a viewing transformation matrix W is given. Equation 10 is used when a three-dimensional Gaussian is projected onto a two-dimensional image.

J means a Jacobian matrix that affine approximation is performed on perspective transformation. A 2×2 variance matrix may be derived from a matrix Σ′.

In Equation 10, Σ is a three-dimensional covariance matrix, and when a scaling matrix and a rotation matrix are given, it may be derived through the following Equation.

$$\sum = {RSS}^{T} {R}^{T} \qquad [ Equation 11 ]$$

In Equation 11, a scaling matrix may be expressed by a three-dimensional vector and a rotation matrix may be expressed by a quaternion.

When modeling the Gaussian probability distribution of a light source radiating toward the center of a three-dimensional shape through equations described, an attribute such as directional color (intensity) information, scaling information and/or rotation information may be required.

Here, directional color (intensity) information may be represented using a spherical harmonic function coefficient. Directional color (intensity) information may be represented in a vector format or a hash code or may be expressed in a feature vector or a matrix format that configures a Multi-Layer Perceptron (MLP) neural network learned by a deep learning-based algorithm.

Scaling information and/or rotation information may also have a matrix form, a feature vector or an MLP neural network matrix form.

Alternatively, as described above through FIG. 11, attribute information may be represented in the form of a layer.

In this case, each layer image may be generated so that attributes for the same vertex (or Gaussian) are arranged in the same space on a two-dimensional plane.

For example, directional color (intensity) information, e.g., the coefficients of a spherical harmonic function may be arranged to have spatial continuity. In other words, the elements of each component (attribute) may be sorted into a one-dimensional or two-dimensional array so that adjacent information has similar data distributions. In this case, a two-dimensional array represents the form of an image plane.

For this purpose, an image plane corresponding to each Gaussian's position information (i.e., the coordinate of x, y and z axes corresponding to an element) may be defined as a separate layer image. Specifically, separate layer images showing a x-axis position, a layer image showing a y-axis position and a layer image showing a z-axis position may be additionally generated.

The position of the element of a specific component (attribute) in a layer image may be arranged based on the position of a corresponding Gaussian.

For example, if the position of a first Gaussian in a two-dimensional image is designated as a (u1, v1) coordinate, then transparency, scaling information, rotation information, position information, etc. for that Gaussian may be assigned to the (u1, v1) coordinate in the corresponding layer image.

In other words, information on a specific position between a plurality of layer images may be for one Gaussian.

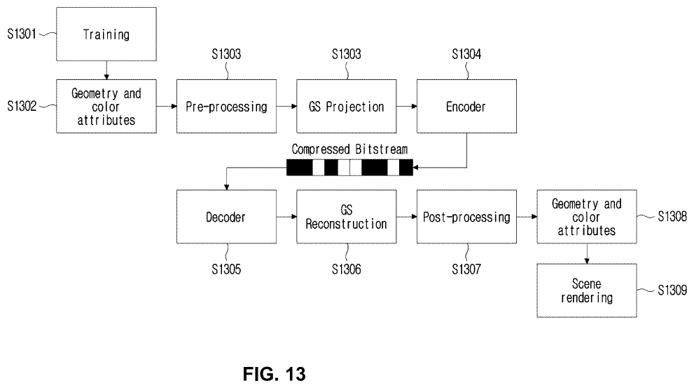

As described above, directional color (intensity) information, transparency information, scaling information, rotation information, position information (x, y, z coordinates), etc. representing the attribute of a three-dimensional vertex (i.e., Gaussian) expressed above may be represented in the form of a planar matrix, a feature vector or an MLP neural network matrix. Listed attribute information may be encoded/decoded according to a process in FIG. 13.

FIG. 13 represents a process of encoding/decoding attribute information of a vertex (i.e., Gaussian).

First, in order to represent a three-dimensional target scene well, each vertex (i.e., Gaussian) attribute may be learned S1301.

Through a learning process, attribute information such as color component (attribute) information and geometry component (attribute) information may be derived S1302. Here, color and geometry component information may include at least one of directional color (intensity) information, transparency information, scaling information, rotation information or position information (x, y, z coordinates).

Afterwards, before encoding corresponding components, a preprocessing step for components may be performed S1303. A preprocessing step may include a pruning process for pruning the above-described overlapping or redundant component information and others.

The color and geometry component information may be converted according to a specific standard required for encoding and compression S1304. For example, when compression is performed by a conventional video compression technique, the preprocessing step such as projecting color and geometry component information onto a two-dimensional planar image and applying quantization may be performed.

Color and geometry component information, once converted to a standardized format may be encoded and compressed for transmission S1305. The resulting compressed bitstream may be transmitted to a user's receiving terminal through a communication network.

A receiving terminal may decode a received compressed bitstream and reconstruct color and geometry component information projected into a two-dimensional image format, into a three-dimensional data format S1305 and S1306. Afterwards, the color and geometry component information may be reconstructed through a postprocessing process corresponding to the preprocessing process S1307 and S1308.

Based on reconstructed color and geometry component information, a target viewpoint image may be synthesized and reconstructed S1309.

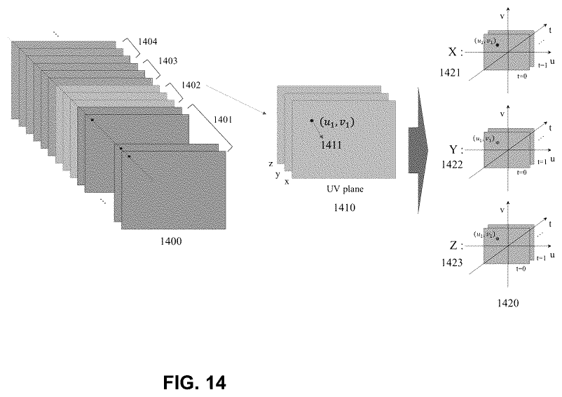

FIG. 14 represents an example in which a three-dimensional scene representation method is extended along the time axis.

In FIG. 14, sign 1400 represents an example in which color and geometry component information expressing a three-dimensional target scene are expressed as a two-dimensional image plane, respectively. As an example of color and geometry component information, sign 1401 may represent directional color (intensity) information. As an example, directional color (intensity) information may be a spherical harmonic function coefficient. Sign 1402 represents position information of a vertex and sign 1403 represents scaling information of a vertex. Sign 1404 may represent rotation information of a vertex. Although not shown, transparency information, etc. may also be included in color and geometry component information.

Sign 1400 represents only static information of a target scene.

When a target scene is filmed for a certain period of time, extension to a time axis is required to express a dynamic scene. Sign 1420 represents an example in which position information is extended to a time axis.

Sign 1402 represents vertex position information on a three-dimensional space. Specifically, sign 1402 represents an image plane including x-axis position information, an image plane including y-axis position information and an image plane including z-axis position information.

The coordinates of a specific vertex 1411 may be aligned to the same (u1, v1) position across three image planes. In other words, since position information of each vertex is expressed at the same location, motion compensation information for representing temporal variation may be defined based on the UV plane.

For example, for a vertex 1411 located at position (u1, v1), the x-coordinate, a y-coordinate and a z-coordinate at time t may be represented by signs 1421, 1422, and 1423, respectively. Afterwards, if it is assumed that a case where t is 0 is a reference frame on the time axis, when the time axis image plane is extended to t+1, t+2, . . . , t+a, the vertex of a t+a plane may be expressed as information that a vertex position is changed at time t+a compared to a reference plane (i.e., t=0) (i.e., the motion compensation information of a vertex).

Here, motion compensation information may be the absolute value of component information at a corresponding time axis. Alternatively, motion compensation information may be a difference value between component information at a corresponding time axis and component information in a reference plane.

In addition, motion compensation information may be a component information value explicitly expressed as a floating or integer type. Alternatively, motion compensation information may be a feature vector or an MLP neural network matrix learned through a deep network-based training process that is an implicit representation method.

In order to encode/decode scene representation information extended along the time axis, intra-frame information corresponding to a keyframe (i.e., information representing the reference plane) and inter-frame information represented as motion compensation information may be encoded and transmitted as metadata. In addition, information indicating which of a x-axis, a y-axis and a z-axis each time-axis plane corresponds to, intra-period information indicating the number of time-axis planes or quantization parameters may also be encoded and transmitted as metadata. Here, The quantization parameters may be used to quantize normalized values when each component information is stored in an image plane format.

The name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. An image encoding method, comprising:
deriving coefficients of a spherical harmonic function for a plurality of vertices on a three-dimensional space;
generating a plurality of layer images based on the coefficients; and
encoding the plurality of layer images,
wherein each of the plurality of layer images includes a coefficient value in an order corresponding to the spherical harmonic function.

2. The method of claim 1, wherein:
the vertices on the three-dimensional space form a plurality of reference planes,
the plurality of layer images correspond to one of the plurality of reference planes.

3. The method of claim 2, wherein:
a resolution of the each of the plurality of layer images is equal to a size of an array of vertices included in a corresponding reference plane.

4. The method of claim 2, wherein:
a transparency image including a transparency value of vertices included in a reference plane is additionally generated.

5. The method of claim 4, wherein:
a number of the layer images for the reference plane corresponds to a number of the coefficients,
a number of the transparency images for the reference plane is 1.

6. The method of claim 4, wherein:
as many transparency images as a number of the layer images are generated.

7. The method of claim 6, wherein:
at least one of a position or a size of a valid region is different between the transparency images.

8. The method of claim 1, wherein:
an attribute of the each of the plurality of layer images is designated as a texture.

9. The method of claim 1, wherein:
an attribute of a first layer image including a first coefficient value among the plurality of layer images is different from an attribute of a second layer image including a coefficient value other than the first coefficient.

10. The method of claim 1, wherein:
metadata including directional image configuration information is additionally encoded.

11. The method of claim 10, wherein:
the directional image configuration information includes at least one of number information of the layer images or number information of the coefficients.

12. The method of claim 10, wherein:
the directional image configuration information includes basis function information for the spherical harmonic function.

13. The method of claim 10, wherein:
the directional image configuration information includes interval information between reference planes.

14. An image decoding method, comprising:
decoding a plurality of layer images; and
reconstructing a target scene based on the decoded layer images,
wherein based on the decoded layer images, coefficients of a spherical harmonic function for a plurality of vertices on a three-dimensional space are reconstructed,
wherein each of the plurality of layer images includes a coefficient value in an order corresponding to the spherical harmonic function.

15. A computer readable recording medium recording instructions for executing an image encoding method, comprising:
deriving coefficients of a spherical harmonic function for a plurality of vertices on a three-dimensional space;
generating a plurality of layer images based on the coefficients; and
encoding the plurality of layer images,
wherein each of the plurality of layer images includes a coefficient value in an order corresponding to the spherical harmonic function.
